(19) United States
(12) Patent Application Publication
(10) Pub. No.: US 2010/0131657 A1
(43) Pub. Date: May 27, 2010

(54) Novel method and system of anonymizing real time Internet communications between peers

(76) Inventors: Fazal Raheman, Nagpur (IN); Donald Mossman, Blackstone, MA (US)

Correspondence Address: PANDISCIO & PANDISCIO, P.C., 470 TOTTEN POND ROAD, WALTHAM, MA, 02451-1914, US

(21) Appl. No.: 12/590,324

(22) Filed: Nov. 5, 2009

Related U.S. Application Data
(63) Continuation of application No. 11/701,750, filed on Feb. 2, 2007, now abandoned.
(60) Provisional application No. 60/764,682, filed on Feb. 3, 2006.

(51) Int. Cl. G06F 15/16

(52) U.S. Cl. 709/227

(57) ABSTRACT

A method and system of establishing a direct communication between two peers over the Internet without revealing their real identities and personal information to each other, comprising of a first client node, a second client node, an intermediate anonymizer server node, the first anonymizer interface and the second anonymizer interface.

### REFERENCE TO PENDING PRIOR PATENT APPLICATION

This patent application claims benefit of pending prior U.S. Provisional Patent Application Ser. No. 60/764,682, filed Feb. 3, 2006 by Fazal Raheman et al. for A NOVEL METHOD AND SYSTEM OF ANONYMIZING REAL TIME INTERNET COMMUNICATIONS BETWEEN PEERS (Attorney's Docket No. MOSSMAN-2 PROV), which patent application is hereby incorporated herein by reference.

### STATEMENT REGARDING FEDERALLY SPONSORED RESEARCH OR DEVELOPMENT

Not Applicable

### REFERENCE TO A MICROFICHE APPENDIX

Not Applicable

### TECHNICAL FIELD

A novel method of real time communicative data exchange over the

Internet between two peers, who wish to communicate with each other without yet disclosing any of their personal contact information such as telephone number or VOIP or text messenger ID.

### BACKGROUND OF THE INVENTION

VOIP has revolutionized telecommunications. It has brought down the cost of International calling to almost nothing. Skype, by far the most successful P2P VolP solution, clocking an unprecedented 245 million downloads till this date has already had a major impact on the entire Telecom industry. Skype has revolutionized VolP telephony by offering unmatched quality and by reducing cost for Skype-to-Skype calls to zero and to a fraction of current long-distance rates for Skype-to-Fixed/Mobile network calls. All the other messenger services such as Yahoo Messenger with Voice, GoogleTalk, MSN Messenger, and Triton are now incorporating VOIP in their messenger services. As VOIP is becoming a standard facility in the messenger applications, the dating services are still not adapt to using such messenger services. The Internet dating industry still largely uses the email communications. This is largely because the VOIP PC to PC communications of today does not offer the dating individuals privacy and anonymity. The instant invention provides a completely private and anonymous communication method ideally suitable for a dating community.

### DESCRIPTION OF THE PRIOR ART

There is large amount of prior art in real time Internet communications in general and instant messenger or communicator applications in particular. Virtually every Internet content provider offers a instant messenger client to its users. Yahoo messenger, MSN messenger, Skype, ICQ, AOL, the list is countless. There is also significant prior art in anonymizing the Internet surfing, email communications, but anonymizing a real time voice and text chat is deficient in the prior art. Phone Matrix, Inc. recently launched a “PrivateCall” service to anonymize a phone to phone call, in which a server first connects the telephone of the caller who initiates the call and then calls the telephone of the person who receives the call. Neither of the persons connected in such a manner know each other's telephone numbers. The PrivateCall does provide anonymity in a clearly defined setting, but offers no technological basis for anonymizing the entire range of PC to PC or PC to phone communications.

The only instance when any prior art attempted anonymity in calls routed through Internet messenger application is U.S. application Publication No. 2004/0081138 (Apr. 29, 2004), in which “the invention enabled the use of Internet services, such as messenger services, through a subscriber connection belonging to some other network than the Internet.” Another application Publication No. 2003/0028599 (Feb. 6, 2003) describes some level of anonymous communication in “communication networks in which an entity may contact another entity over heterogeneous networks via an alias identifier, the entity being a person, application or device.” However, complete anonymity in all types of homogenous or heterogonous networks and all types of text or voice communication means, still remains a high unmet need, which the instant invention meets.

The need for security and privacy of members of a personals website, and the speed with which they can find their soul mates make Internet dating industry a prime target for advancement of the messenger/communicator applications of the prior art. None of the disclosures in the prior art satisfy the unmet needs of further improvising the security, privacy and efficiency of the Internet dating industry.

### BRIEF SUMMARY OF THE INVENTION

The definition of real identity for the purpose of this description is either the user's telephone number, published email address or the Internet Messenger ID disclosed to his Internet Messenger contacts. Virtual identity for the purpose of this description means an ID created for communicating on a special private and anonymous forum yet using a communication medium with already published ID.

The full integration of a completely anonymous real time communication through all types of networks is not possible in the current messenger applications on account of limitation of such applications in masking VOIP ID or telephone number of the user desired to be contacted. It would be an improvement to is provide a new method of enhancing the privacy of direct PC to PC or PC to Phone communications of the members of a dating website, using an intermediate node to anonymize such communications. Consequently, it is an advantage of the invention that a member of dating website can directly communicate through all possible means of communication without ever having to provide telephone number, VOIP messenger ID or email IM IDs.

It is therefore an object of the present invention to provide a user friendly, privacy-enhancing, time-saving, value adding anonymizing interface for direct real time communications between peers. It is another object of the invention to innovate the currently available messenger/communicator client applications to enable users to find new friends or contacts without having to disclose to them even their messenger/communicator IDs.

It is yet another object of the present invention to eliminate or minimize weeks and months of email communications between peers and provide direct voice communication between them so they can quickly evaluate their compatibility for a relationship.

It is yet another object of the instant invention to integrate a highly private VOIP functionality into the personals/relationships/community forums on the World Wide Web.

The foregoing discussion summarizes some of the more pertinent objects of the present invention. These objects should be construed to be merely illustrative of some of the more prominent features and applications of the invention. Applying or modifying the disclosed invention in a different manner can attain many other beneficial results or modifying the invention as will be described. Accordingly, referring to the following drawings may have a complete understanding of the invention. Description of the preferred embodiment is as follows.

### BRIEF DESCRIPTION OF THE SEVERAL VIEWS OF THE DRAWINGS

FIG. 1 is a block diagram illustrating the network architecture of a preferred embodiment implemented through three nodes.

### DETAILED DESCRIPTION OF THE INVENTION

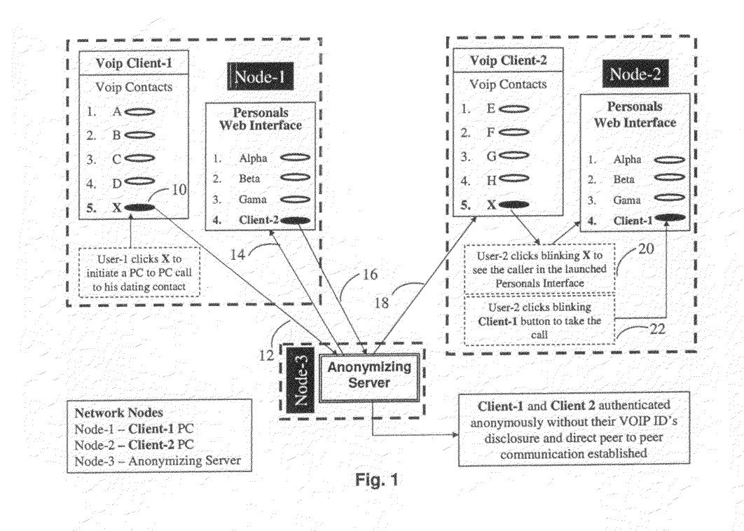

The novel features of the instant invention can be deployed in any peer to peer or client-server-client messenger/communicator application. The preferred embodiment of the invention is however described, as it would be implemented in anonymizing the identities of the members of a dating website. As represented in FIG. 1 the preferred embodiment of the present invention is implemented through a network of at least three Nodes. The practical implementation of the preferred embodiment is described in terms of a member of a dating website at Node-I (Client-1 PC) desiring to establish contact with one of his favorite members at Node-2 (Client-2 PC), for the purpose of a voice or text communication. The

Node-1 and Node-2 Clients are a traditional VOIP enabled messenger/communicator application of the prior art displaying a list of the client user's contacts. All the links to client users' contacts directly establish communication with their peers. There is however one link (identified as Contact X in the list of Client-1 and Client-2 messenger contacts), which links to the Node-3 intermediate anonymizing server. It is through this link that the members of the dating website communicate with each other in complete anonymity as described herein.

The practical implementation of the preferred embodiment begins when User-1, who wants to initiate a private PC to PC call to his dating contact (Client-2), clicks on the X link 10 of the Client-1 messenger. The X link request 12 is sent to the anonymizing server, which delivers a Web page interface 14 with the list of User-1's dating contacts including Client-2 (User-2). On clicking the Client-2 link 16 the communication request is finally delivered to the Node-3 server, which routes it 18 to the desired contact. The incoming communication request from

Client-1 is displayed on the Client-2 messenger as blinking X link. In order to identify the caller, the User-2 clicks the blinking X link 20, which launches a Web page displaying the list of her dating contacts. The incoming call from User-1 is identified as a blinking Client-1 link. If the User-2 wishes to take the incoming call from User-1, she clicks the blinking Client-1 link 22, which authenticates both users anonymously and their voice communication link is established.

Although the above implementations refer to a dating infrastructure, the principles apply equally to any other communication setting warranting complete anonymity and privacy. The present invention has been shown in the described embodiments for illustrative purposes only. Further, the terms and expressions which have been employed in the foregoing specification are used as terms of description and not of limitation, and there is no intention, in the use of such terms and expressions, of excluding equivalents of the features shown and described or portions thereof, it being recognized that the scope of the invention is defined and limited only by the claims which follow.

What is claimed as a novel invention is:

1. A method of establishing a direct communication between two peers over the Internet without revealing their real identities and personal information to each other, the method comprising a first client node, a second client node, an intermediate anonymizer server node, the first anonymizer interface and the second anonymizer interface.

2. The method of claim 1 wherein the first client node is a personal computer.

3. The method of claim 1 wherein the first client node is a hand held communication device.

4. The method of claim 1 wherein the first client node uses a VOIP enabled Internet messenger application that displays amongst the first client's list of contacts, a link to the intermediate anonymizer server node.

5. The method of claim 1 wherein the first client initiates the communication with the second client by clicking on the link to the intermediate anonymizer server node.

6. The method of claim 1 wherein the second client node is also a personal computer that receives the communication initiated by the first client.

7. The method of claim 1 wherein the second client node is a communication device.

8. The method of claim 7 wherein the communication device is a handheld wireless mobile device.

9. The method of claim 7 wherein the communication device is a landline telephone device.

10. The method of claim 1 wherein the anonymizer server uses the clients' real identification to connect to their devices but uses their virtual IDs to identify the clients to each other through their corresponding anonimizer interfaces.

11. The method of claim 1 wherein the first client anonimizer interface displays a list of first client's list of anonymous contacts each identified only by their virtual identification and corresponding buttons to establish a communication link with the contacts.

12. The method of claim 11 wherein the anonymous contacts' communication links display the current availability status of all of his contacts.

13. The method of claim 1 wherein the second client anonimizer interface displays the calling client's virtual identification only.

14. A system of establishing a direct communication between two peers over the Internet without revealing their real identities and personal information to each other, the system comprising a first client node, a second client node, an intermediate anonymizer server node, the first anonymizer interface and the second anonymizer interface.
